(19) United States
(12) Patent Application Publication
(10) Pub. No.: US 2017/0101554 A1
(43) Pub. Date: Apr. 13, 2017

(54) SEMI-SCORED DOUBLE-SIDED TAPE PRODUCT AND METHOD OF PRODUCING THE SAME

(71) Applicant: PLUS Corporation, Tokyo (JP)

(72) Inventor: Takashi Yasuzawa, Tokyo (JP)

(21) Appl. No.: 15/385,755

(22) Filed: Dec. 20, 2016

Related U.S. Application Data
(62) Division of application No. 14/728,924, filed on Jun. 2, 2015.

(30) Foreign Application Priority Data
Jun. 24, 2014 (JP) 2014129675

(51) Int. Cl. C09J 7/02; B32B 7/06; C09J 167/02; B32B 37/00; B32B 38/00; B65H 75/40; B32B 3/10; B32B 7/12

(52) U.S. Cl. CPC C09J 7/0232; B32B 3/10; B32B 7/06; B32B 7/12; B32B 37/0053; B32B 37/025; B32B 38/0004; B65H 75/406; C09J 167/02; B32B 2038/045

(57) ABSTRACT

To provide a method of producing a semi-scored double-sided tape product at lower costs and with a lower defect rate. A bonded composite tape 100 is fed from a first feeder reel 310 to a first tape-up reel 320. The bonded composite tape 100 includes a tape for production use and a double-adhesive laminate of a double-sided tape type. A die cut roll 340 is used for cutting only the double-adhesive laminate of the bonded composite tape 100 into a plurality of rectangular pieces as adhesive tape segments each having an appropriate length. On the other hand, a release tape 200 is fed from a second feeder reel 410 to a second take-up reel 420. The release tape 200 comes into contact with a part of the bonded composite tape 100 that is located downstream the die cut roll 340. The adhesive tape segments are then adhered to the release tape 200.

### CLAIM OF PRIORITY TO RELATED APPLICATION

This application is a divisional of U.S. application Ser. No. 14/728,924, filed on Jun. 2, 2015, which claims priority from Japanese Patent Application No. 2014-129675 filed Jun. 24, 2014, the disclosure of which is incorporated herein by reference in its entirety.

### BACKGROUND OF THE INVENTION

Technical Field

The present invention relates to double-sided tape products.

Background Art

Double-sided tape products generally have a long thin piece of backing material with adhesive layers on both sides thereof (which is also referred herein to as a double-adhesive laminate) and a release tape applied to one of the adhesive layers. Such double-sided tape products are often available in the form of roll. The release tape serves to prevent the adjacent adhesive layers from sticking to each other and to enable proper unwinding of the roll.

In use, a user pulls a double-sided tape product including the release tape and cuts it to an appropriate length. He or she places the sticky side of the piece (i.e., the adhesive layer that is not covered with the release tape) onto a desired surface of an item, peels off the release tape to uncover the adhesive layer, and then attaches another item to be joined to the just exposed adhesive layer.

Alternatively, some double-sided tape products have small adhesive pieces aligned on a release tape obtained by cutting, on the release tape, a double-adhesive laminate into rectangular pieces. The double-sided tape products of this kind are herein referred to as a “semi-scored double-sided tape product.” Such semi-scored double-sided tape products are typically contained in a handheld applicator similar to those used for glue tape or transferable adhesive. The adhesive pieces on the release tape are fed to a transfer unit of the applicator and are successively transferred to a desired surface of an item. In other words, when one adhesive piece is stuck to the surface of the item, the corresponding part of the release tape is removed from that piece. This means that the application of the adhesive piece to a desired surface is made concurrently with the automatic removal of the release tape at that part. An item to be joined can be applied to the uncovered adhesive layer without requiring a user to remove the release tape with his or her fingers.

Semi-scored double-sided tape products are not widely used at the present, but have a significant growth potential in the future because of their advantages as follows. The used release tape is typically collected in an applicator and thus no piece of used release tape is left. There is no need for users to cut out a tape product or to care about the length of a cutout before application to a surface of an item.

The semi-scored double-sided tape products, however, still need to be improved in terms of costs of their production that are likely to be high.

Semi-scored double-sided tape products are typically produced by cutting a double-adhesive laminate, previously attached to a release tape, into small pieces in the widthwise direction without cutting or at least without completely cutting the release tape.

This involves cutting of the double-adhesive laminate alone, of the combination of the release tape and the double-adhesive laminate which are both very thin and are bonded closely together. Operation of the blades used for cutting should precisely and accurately be controlled, but this is often challenging and thus tends to increase costs of production. If a release tape is cut excessively, the semi-scored double-sided tape product with such a release tape is considered defective. The resulting lower yields can also increase the costs of production. In addition, distribution of these defective semi-scored double-sided tape products might result in claims by consumers.

Furthermore, moving blades can only be controlled so precisely or accurately and the thickness of the release tape can thus only be reduced so much. In current technical environments, the lower limit of thickness of the release tape is 25 μm for polyethylene terephthalate (PET) on a commercial basis in consideration of the yields. If the semi-scored double-sided tape products are supplied to users in the form of roll, thinner release tapes have significant benefits because the diameter of a roll can be reduced without compromising the length of the product, which in turn helps reducing the size of the applicator, or the length of the product can be increased without changing the size of the roll.

A principle object of the present invention is to provide a method of producing semi-scored double-sided tape products with which semi-scored double-sided tape products can be produced at lower costs and with a lower defect rate and the thickness of a release tape can be reduced if necessary.

### BRIEF SUMMARY OF THE INVENTION

In order to solve the aforementioned problem, the present inventor proposes the following invention.

What the present inventor proposes is a method of producing a semi-scored double-sided tape product comprising producing a bonded composite tape by applying one adhesive layer of a double-adhesive laminate having adhesive layers on both sides thereof to one side of a tape for production use; cutting the double-adhesive laminate into a plurality of adhesive tape segments on the tape for production use by means of successive semi-scoring of the fed bonded composite tape to cut only the double-adhesive laminate without completely cutting the tape for production use, each adhesive tape segment having an appropriate length; and contacting one side of a release tape with the adhesive tape segments on the tape for production use over a predetermined range wherein the release tape is fed side by side with the bonded composite tape after semi-scoring, and transferring the adhesive tape segments to the contacted side of the release tape to produce a semi-scored double-sided tape product, each adhesive tape segment having the appropriate length and being transferable to a predetermined surface.

In the method of producing a semi-scored double-sided tape product according to the present invention (hereinafter, also merely referred to as a production method), semi-scoring is made to the bonded composite tape including the tape for production use. The plurality of adhesive tape segments obtained by semi-scoring are transferred to one side of the release tape to produce a final semi-scored double-sided tape product.

This method of producing a semi-scored double-sided tape product does not involve semi-scoring (partial cutting) to the release tape which is a part of the final semi-scored double-sided tape product. This eliminates the risk of defects of release tapes due to unwanted cut(s) formed therein. The tape for production use does not necessarily have specifications required for the release tapes because it is a material used only during the production process. For example, the tape for production use may be thicker than the release tape. A thicker tape for production use can eliminate the need for precise or accurate control of semi-scoring to the bonded composite tape, suppressing increase in costs of production.

The term “semi-score” or “semi-scoring” as used herein refers to partly cut a laminate of two tapes (or tape-like materials) by pressing a blade into either one of the tapes to (1) completely cut the tape where the blade enters without cutting the other tape or to (2) completely cut the tape where the blade enters and partly cut the other tape in a direction along the depth (thickness) thereof.

As described above, the method of producing a semi-scored double-sided tape product according to this application does not use no semi-scoring to the release tape, so that there is a no risk of producing a cut into the release tape which otherwise occurs during semi-scoring. As a result, with the method of producing a semi-scored double-sided tape according to this application, the thickness of the release tape can be reduced.

For example, the release tape may be thinner than the tape for production use. Accordingly, it may be easier to use a thicker tape for production use in the bonded composite tape to be subjected to semi-scoring as long as the semi-scoring does not become difficult, and to reduce the thickness of the release tape to such a degree that can provide benefits for users.

In addition, in the present invention, the release tape may have a thickness of smaller than 25 μm. As described above, the lower limit of thickness of the release tape is 25 μm in conventional methods of producing semi-scored double-side tape products where semi-scoring is made to release tapes. In contrast, the production method according to this application allows the use of a release tape having a thickness of smaller than 25 μm. In the production method according to this application, the thickness of the release tape may be smaller than 20 μm or may be, for example, even around 12 μm which is about half the thickness of conventional release tape. These thicknesses of the release tape can also apply to release tapes made of PET.

The present invention includes a step of cutting the double-adhesive laminate into a plurality of adhesive tape segments on the tape for production use by means of successive semi-scoring of the fed bonded composite tape to cut only the double-adhesive laminate without completely cutting the tape for production use, each adhesive tape segment having an appropriate length. The length or the shape of the adhesive tape segment can be determined, for example, appropriately in consideration of easiness of transfer of the adhesive tape segments on one side of the release tape to a predetermined surface during the use of the semi-scored double-sided tape, and easiness of semi-scoring of the bonded composite tape. It is not necessary that all adhesive tape segments have the same length and/or the shape.

The semi-scoring in the aforementioned step may be made in a direction along, for example, a line crossing the widthwise direction of the bonded composite tape, along a curved line, or along the width of the bonded composite tape.

Semi-scoring along the widthwise direction of the bonded composite tape produces rectangular adhesive tape segments. Each adhesive tape segment may have a rectangular shape with the length shorter than the width of the bonded composite tape. It is preferable that the length of each adhesive tape segment is, for example, equal to or shorter than 3 mm, such as equal to or shorter than 1 mm in consideration of easiness of transfer of the adhesive tape segments to a predetermined surface.

To feed the bonded composite tape, it may be fed from, for example, a roll on which the bonded composite tape is wound. To feed the release tape, it may be fed from, for example, a roll on which the release tape is wound.

The present inventor also proposes the following semi-scored double-sided tape product.

An example of the semi-scored double-sided tape product is a semi-scored double-sided tape product including adhesive tape segments applied to one surface of a release tape in such a manner that they are transferable to a predetermined surface, each adhesive tape segment having an appropriate length and having adhesive layers on both sides thereof, wherein the release tape has a thickness of smaller than 25 μm.

No conventional semi-scored double-sided tape products have such a thin release tape. For example, if the semi-scored double-sided tape products are supplied to users in the form of roll, the diameter of a roll can be reduced without compromising the length of the product, or the length of the product can be increased without changing the size of the roll.

Furthermore, the present inventor proposes an applicator for transferring semi-scored double-sided tape products.

An example of the applicator for transferring semi-scored double-sided tape products is an applicator for transferring semi-scored double-sided tape products including a first spool on which a semi-scored double-sided tape product is wound, the semi-scored double-sided tape product comprising adhesive tape segments applied to one surface of a release tape in such a manner that they are transferable to a predetermined surface, each adhesive tape segment having an appropriate length and having adhesive layers on both sides thereof; a transfer unit for transferring the adhesive tape segment of the semi-scored double-sided tape product unwound from the first spool, to the predetermined surface; a second spool adapted to take up the semi-scored double-sided tape product that has passed across the transfer unit; and a handheld case, the first spool and the second spool being contained in the handheld case, the transfer unit being exposed from the handheld case, wherein the release tape has a thickness of smaller than 25 μm.

There are no conventional applicators for semi-scored double-sided tape products with such a thin release tape. For example, when a given length of semi-scored double-sided tape product is wound on the first spool, the semi-scored double-sided tape product in the form of roll has a smaller diameter than before, which in turn contributes to the reduction in size of the applicator transferring for semi-scored double-sided tape products. When the size of the applicator transferring for semi-scored double-sided tape products is identical to the size of the applicators used conventionally, a longer semi-scored double-sided tape product can be used.

### BRIEF DESCRIPTION OF THE DRAWINGS

FIG. 1 is a side view for schematically describing a method of producing a semi-scored double sided tape product according to one embodiment of the present application;

FIG. 2 is an enlarged side view of a die cut roll and its surroundings in FIG. 1;

FIG. 3 is an enlarged side view of contacted parts of a bonded composite tape and a release tape in FIG. 1;

FIG. 4 is a side view schematically showing a configuration of an applicator transferring for semi-scored double sided tape products in which a semi-scored double sided tape product obtained by using a method of producing the same according to an embodiment of the present application is applied;

FIG. 5 is a side view schematically showing how the applicator transferring for semi-scored double sided tape products in FIG. 4 is used; and

FIGS. 6(A) and 6(B) are a plan view and a side view, respectively, of adhesive tape segments transferred to a surface of an item using the applicator in FIG. 4.

### DETAILED DESCRIPTION OF THE INVENTION

A preferred embodiment of the present invention is described below with reference to the drawings.

An embodiment of a method of making a semi-scored double sided tape product according to this application is described first.

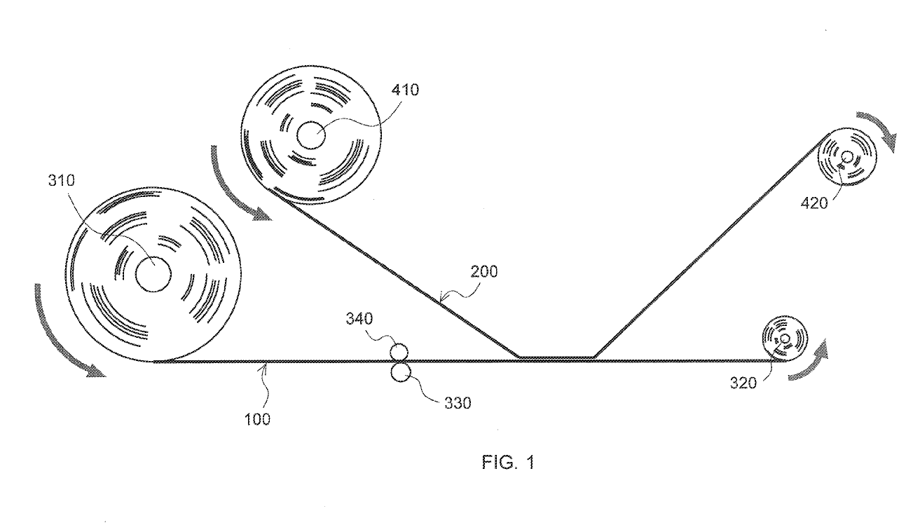

To make a semi-scored double sided tape product according to this application, two different tape-shaped materials are used as shown in FIG. 1.

Although the bonded composite tape 100 may have the same width as that of a final product, it is considerably wider than the final product in this embodiment. The semi-scored double sided tape product (more precisely, a much wider web of the semi-scored double sided tape product) is cut into thin strips to produce final, semi-scored double sided tape products.

The width of the bonded composite tape 100 is, for example, 200 to 400 mm, but not limited thereto.

The bonded composite tape 100 is initially wound on a first feeder reel 310. The bonded composite tape 100 on the first feeder reel 310 is withdrawn therefrom and taken up on the first tape-up reel 320. The first feeder reel 310 and the first tape-up reel 320 rotate synchronously with each other in the direction depicted by arrows shown near the reels 310 and 320 in FIG. 1. The bonded composite tape 100 is fed from the first feeder reel 310 to the first tape-up reel 320. The bonded composite tape 100 in this embodiment is fed from the first feeder reel 310 to the first tape-up reel 320 in a straight line but not limited thereto. It is preferable that the bonded composite tape 100 is fed from the first feeder reel 310 to the first tape-up reel 320 with less slack in the tape. In order to make sure that there is less or no slack, or alternatively, in order to change the direction of movement of the bonded composite tape 100, it is obvious that a known or well-known technique may be used such as by appropriately providing a roller or rollers (not shown) rotating actively or passively with the surface thereof contacted against the bonded composite tape 100. In addition, as shown in FIG. 1, an anvil roll 330 can be provided at an appropriate place beneath the moving bonded composite tape 100. The anvil roll 330 provides support for the bonded composite tape 100 from below and conveys the bonded composite tape 100. In this embodiment, a die cut roll 340 is provided over the anvil roll 330. The die cut roll 340 is for “semi-scoring” the bonded composite tape 100 to cut the double-adhesive laminate 120.

The release tape 200 is slightly wider than the bonded composite tape 100 in order to ensure that the release tape 200 can receive adhesive tape segments transferred from the bonded composite tape 100 to the release tape 200, as described later. The width of the release tape 200 is, for example, 210 to 410 mm but not limited thereto. The release tape 200 is made of a resin material such as PET, but not limited thereto. The release tape 200 is thin to such a degree that it can have a certain amount of toughness. The release tape 200 in this embodiment is thinner than a tape for production use described later but is not limited thereto. The release tape 200 has a thickness smaller than 25 μm but not limited thereto. For example, the release tape 200 has a thickness equal to or smaller than 20 μm. A better effect of the present invention (described later) can be achieved with a thinner release tape 200, and the thickness of the release tape 200 may be reduced to, for example, around 6 μm. As described later, an adhesive layer (described later) of each adhesive tape segment (described later) formed by dividing a length of adhesive tape (described later) attach to both sides of the release tape 200. The release tape 200 is coated on both sides with a known remove agent such as silicone so that each adhesive tape segment can be release comparatively easily from both sides of the release tape 200.

The release tape 200 is initially wound on a second feeder reel 410. The release tape 200 on the second feeder reel 410 is withdrawn therefrom and taken up on a second take-up reel 420. The second feeder reel 410 and the second take-up reel 420 rotate synchronously with each other in the direction depicted by arrows in FIG. 1. The release tape 200 is fed from the second feeder reel 410 to the second take-up reel 420. The lower surface of the moving release tape 200 is forced to contact with the upper surface of the bonded composite tape 100 in a certain region downstream the die cut roll 340. The bonded composite tape 100 and the release tape 200 are fed at the same speed at least in the region where they meet. The release tape 200 in this embodiment is turned to different directions between the second feeder reel 410 and the second take-up reel 420 as shown in FIG. 1, but not limited thereto. It is preferable that the release tape 200 is fed from the second feeder reel 410 to the second take-up reel 420 with less slack in the tape. In order to make sure that there is no or less slack, or alternatively, in order to change the direction of movement of the release tape 200, it is obvious that a known or well-known technique may be used such as by appropriately providing a roller or rollers (not shown) rotating actively or passively with the surface thereof contacted against the release tape 200.

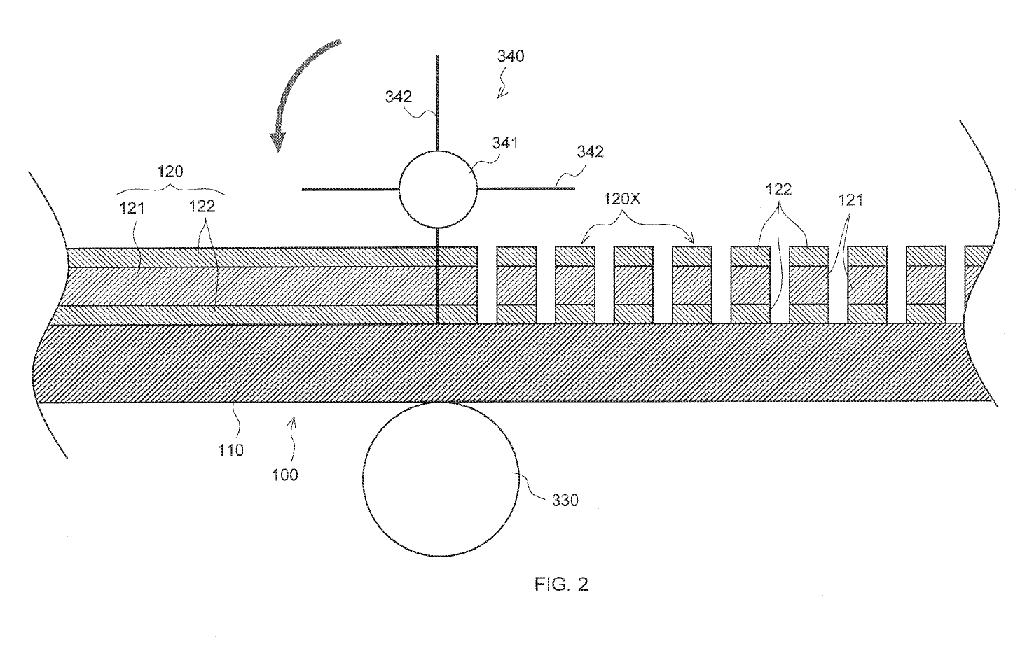

Next, the bonded composite tape 100 is described more in detail. The bonded composite tape 100 has a structure as shown in FIG. 2. The bonded composite tape 100 moves from the left to the right in FIG. 2 and is subjected to semi-scoring to cut the double-adhesive laminate 120 using the die cut roll 340.

The part of the bonded composite tape 100 before semi-scoring, which is located upstream of the die cut roll 340, is just the same condition as it has on the first feeder reel 310.

The bonded composite tape 100 includes the tape for production use 110 and the double-adhesive laminate 120 applied to one surface (the upper surface in FIG. 2) of the tape for production use 110. The double-adhesive laminate 120 includes a backing material tape 121 which is sandwiched between adhesive layers 122.

The tape for production use 110 may be made of a resin and, in this embodiment, made of PET, but not limited thereto. Examples of the material for the tape for production use 110 include glassine coated on both sides with silicone or paper coated on both sides with polyethylene. The tape for production use 110 has a certain amount of toughness. The tape for production use 110 is thick to a degree as long as the subsequent semi-scoring operations are not interfered. The thickness of the tape for production use 110 is in a range of 25 μm to 120 μm, but not limited thereto. More specifically, the tape for production use 110 in this embodiment has a thickness of about 60 μm. The adhesive layer 122 of the double-adhesive laminate 120 attaches to both sides of the tape for production use 110. The tape for production use 110 is coated on both sides with a known release agent such as silicone so that the double-adhesive laminate 120 can be remove comparatively easily from both sides of the tape for production use 110.

The double-adhesive laminate 120 includes the backing material tape 121 and the two adhesive layers 122 covering the both sides of the backing material tape 121, as described above. The backing material tape 121 may be made of paper, but not limited thereto. The backing material tape 121 in this embodiment is made of a tissue sheet paper but not limited thereto. The backing material tape 121 has a certain amount of toughness. The thickness thereof is in a range of 5 μm to 75 μm, but not limited thereto. More specifically, the backing material tape 121 in this embodiment has a thickness of about 30 μm. The adhesive layer 122 is formed of an adhesive. The adhesive for use in forming the adhesive layer 122 may appropriately be selected from known or well-known adhesives. The thickness of the adhesive layer 122 is in a range of 10 μm to 30 μm, but not limited thereto. More specifically, the adhesive layer 122 in this embodiment has a thickness of about 20 μm. The two adhesive layers 122 may be different in material or thickness from each other, but the adhesive layers 122 in this embodiment are the same. Combinations of two different adhesive layers 122 find applications where an item adhered to either adhesive layer 122 may need to be repositioned or removed. This can be achieved by using adhesives of different tacks for the adhesive layers 122 and the adhesive layer that is less sticky is used for repositioning or removal.

As described above, the bonded composite tape 100 is wound on the first feeder reel 310. It is unwound from the first feeder reel 310, moves from the left to the right in FIG. 1, and taken up on the first tape-up reel 320.

The release tape 200 is wound on the second feeder reel 410. It is unwound from the second feeder reel 410, moves from the left to the right in FIG. 1, and taken up on the second take-up reel 420.

In this process, as shown in FIG. 2, the bonded composite tape 100 is subjected to the semi-scoring.

More specifically, the die cut roll 340 is used to semi-score the bonded composite tape 100. The die cut roll 340 has a body member 341 and blade members 342. The body member 341 has, for example, a hollow cylindrical shape from which the blade members 342 project radially outwardly. The body member 341 can rotate about the axis thereof at an appropriate speed in the direction depicted by an arrow in FIG. 2. The blade members 342 rotate with the rotation of the body member 341. Each blade member 342 cuts only the double-adhesive laminate 120 without completely cutting the tape for production use 110 of the bonded composite tape 100 fed from the first feeder reel 310 and supported from below by the anvil roll 330. It is quite difficult to cut literally only the double-adhesive laminate 120 without making any cuts in the tape for production use 110. Any attempts to achieve this can lead to incomplete cutting of the double-adhesive laminate 120. It is therefore better for the anvil roll 330 and the die cut roll 340 to be adjusted so that the blade members 342 enters slightly (usually around 20% of the thickness of the tape for production use 110) into the tape for production use 110. No significant problem arises in production of semi-scored double sided tape products unless the tape for production use 110 is torn completely before being taken up on the first tape-up reel 320. As described above, the tape for production use 110 can be thick to a degree as long as subsequent semi-scoring is not interfered. The tape for production use 110 is hardly damaged deadly during the semi-scoring operations.

In this embodiment, the blade members 342 cut the double-adhesive laminate 120 along the width of the bonded composite tape 100. As used herein, the direction along the width of the bonded composite tape 100 is the direction perpendicular to the direction of feeding the bonded composite tape 100. This cutting of the double-adhesive laminate 120 produces adhesive tape segments 120X. Each adhesive tape segment 120X has a rectangular shape, with the shorter sides in the direction along the length of the bonded composite tape 100 and the longer sides in the direction along the width of the bonded composite tape 100.

The bonded composite tape 100 with the adhesive tape segments 120X formed travels to the right in FIG. 1 across the die cut roll 340.

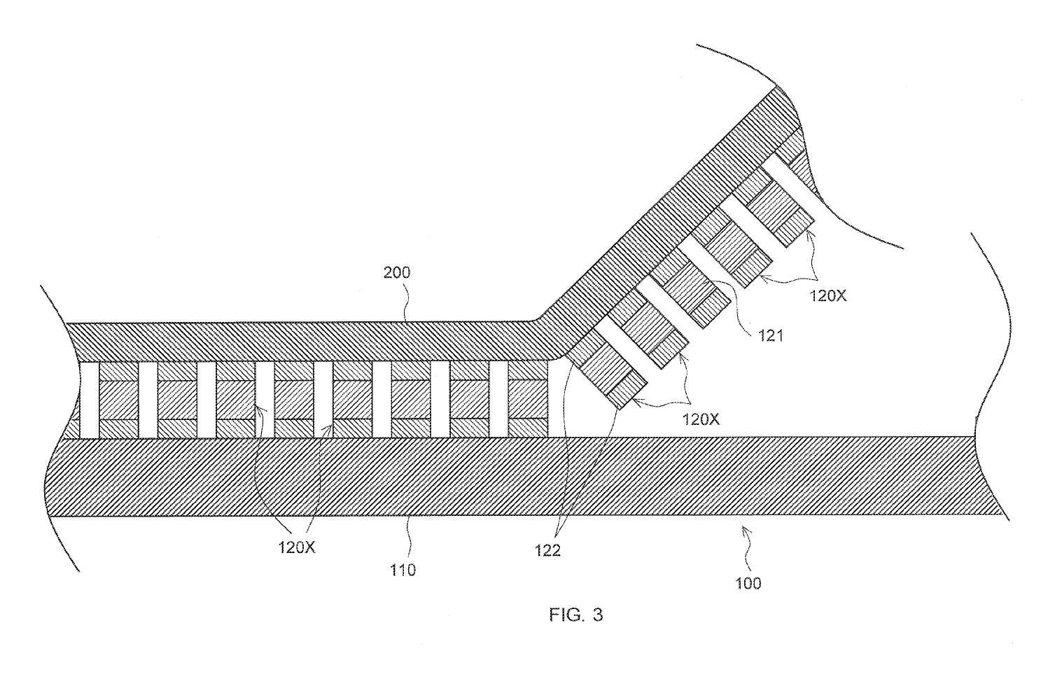

After the bonded composite tape 100 is advanced by a certain amount, the release tape 200 moving at the same speed in the same direction as those of the bonded composite tape 100 is made contact with the surface of the adhesive tape segments 120X in alignment with the bonded composite tape 100 in the width direction (FIGS. 1 and 3). The release tape 200 is directed away from the bonded composite tape 100 while moving, as shown in the right part of FIG. 3. As a result, the adhesive tape segments 120X on the tape for production use 110 adhered to the lower surface of the release tape 200 in FIG. 3 are transferred to the release tape 200 one after another.

It is noted that the strength of the adhesion between each adhesive tape segment 120X and the release tape 200 should be larger than the strength of the adhesion between each adhesive tape segment 120X and the tape for production use 110 in order to provides successful transfer of the adhesive tape segments 120X from the tape for production use 110 to the release tape. The surfaces of the tape for production use 110 and the release tape 200 on which the adhesive tape segments 120X are adhered are pre-treated to meet such requirements.

More specifically, the tape for production use 110 is coated on both sides with a release agent such as silicone. The coating on the back side of the tape 110 (i.e., the lower side in FIGS. 1 and 2) allows unwinding of it from the first feeder reel 310 without transfer of the double-adhesive laminate 120 to the adjacent side. The coating on the top side of the tape 110 (i.e., the upper side in FIGS. 1 and 2) allows smooth removal of the adhesive tape segments 120X therefrom for their good transfer to the release tape 200.

The release tape 200 is also coated on both sides with a release agent such as silicone. The coating on the top side of the tape 200 (i.e., the lower side in FIGS. 1 and 3) allows the adhesive tape segments 120X to stay adhered to the tape 200 when they are separated from the tape 110 but also allows easy removal of the adhesive tape segments 120 from the tape 200 when required, such as when a user applies the adhesive tape segment(s) 120X to a given surface. In addition, the coating on the back side of the tape 200 (i.e., the upper side in FIGS. 1 and 3) allows unwinding of a semi-scored double sided tape product produced from the wound combination of the tape 200 and the adhesive tape segments 120X. It is noted that a pressure may be applied to the bonded composite tape 100 and/or the release tape 200 at a position where they are moving in parallel to each other in order to ensure better transfer of the adhesive tape segments 120X from the tape for production use 110 to the release tape 200.

The bonded composite tape 100, strictly speaking, the tape for production use 110 left behind, is taken up on the first tape-up reel 320.

On the other hand, the release tape 200 carrying the adhesive tape segments 120X on one side is taken up on the second take-up reel 420 as a semi-scored double sided tape product.

In this way, production of the semi-scored double sided tape product is completed.

Although the semi-scored double sided tape product thus obtained can be considered as a final product, it is a “web” of final products in this embodiment. As described above, this semi-scored double sided tape product is cut into thin strips having a width of about 1 cm to produce final products that can be used in an applicator transferring for semi-scored double sided tape products.

Next, an applicator transferring for semi-scored double sided tape products (hereinafter, merely referred to as an “applicator”) in which the aforementioned semi-scored double sided tape product is used is described.

This applicator has is similar in structure and configuration to known or well-known applicators, dispensers, or tape guns for correction tapes, glue or adhesive tapes, or double-sided tapes.

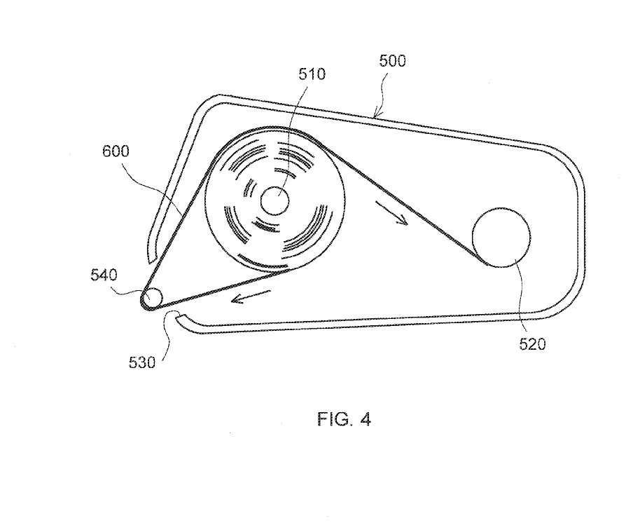

The applicator has a case 500. The case 500 can be held with a hand. The case 500 in this embodiment is flat in the direction parallel to the plane of FIG. 4. The case 500 is made of a resin, and often at least a part of the case 500 is transparent or translucent. The transparency or translucency of at least a part of the case 500 allows a user to see how much tape described below remains therein or to see when tape is running out.

The case 500 contains a first spool 510 and a second spool 520 which can rotate about their respective axes. A semi-scored double sided tape product 600 is wound on the first spool 510, at least when the applicator is brand-new, that is to say, it is not in use yet. The semi-scored double sided tape product 600 is produced using the aforementioned production method and includes a release tape of thinner than 25 μm. The semi-scored double sided tape product 600 is wound on the first spool 510 with the side carrying the adhesive tape segments facing to the outside.

The second spool 520 is for taking up the semi-scored double sided tape product 600. While not illustrated in the drawing, the first spool 510 and the second spool 520 are connected to each other using a known gear mechanism. As the first spool 510 rotates, the second spool 520 also rotates in the same direction as that of the first spool 510.

The case 500 has an opening 530. A hollow cylindrical transfer roller 540 is provided outside the opening 530. The transfer roller 540 is attached to the case 500 using an appropriate method. The transfer roller 540 can rotate about the axis thereof. The semi-scored double sided tape product 600 running between the first spool 510 and the second spool 520 is wrapped around the transfer roller 540.

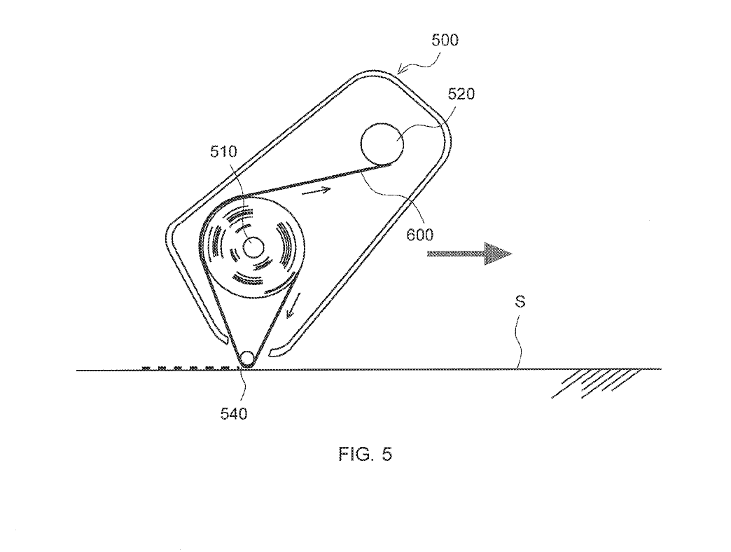

In use, the case 500 of the applicator described just above is held in one hand at an angle, and the semi-scored double sided tape product 600 is pressed via the transfer roller 540 down onto a predetermined surface S onto which the semi-scored double sided tape product 600 is to be applied. The applicator is then rolled in the direction depicted by an arrow in FIG. 5.

The rotating transfer roller 540 pushes the semi-scored double sided tape product 600 against the surface S. With the rotation of the transfer roller 540, the semi-scored double sided tape product 600 is dispensed in the direction from the first spool 510 to the second spool 520. Because of the pressure from the transfer roller 540, the adhesive tape segment(s) on the outer surface of the semi-scored double sided tape product 600 is/are transferred to the surface S following the path of the transfer roller 540.

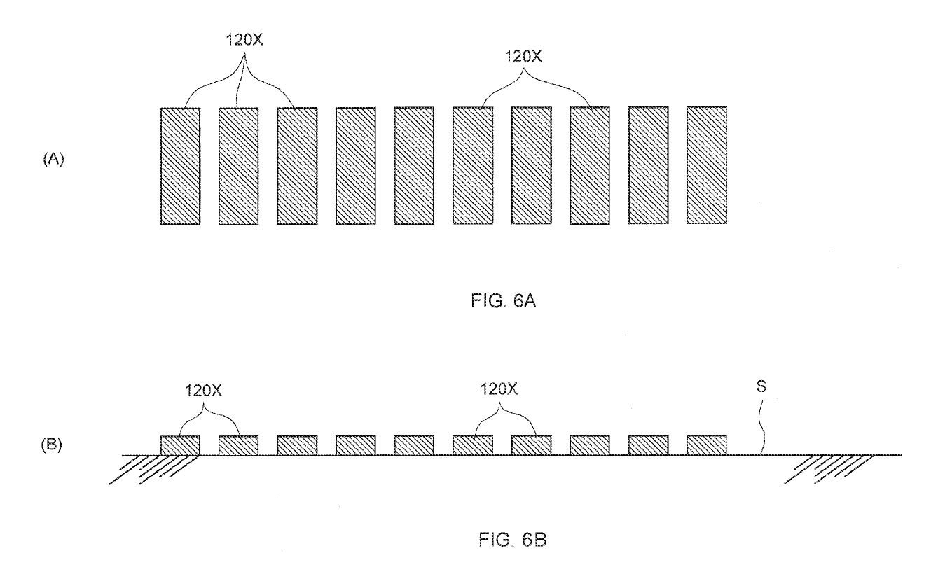

FIGS. 6A and 6B show a plan view and a side view, respectively, of the adhesive tape segments 120X transferred to the surface S. While the adhesive tape segments 120X in this example are aligned straight as seen from the above, they may be applied in curves by controlling the path of movement of the case 500.

The semi-scored double sided tape product 600 running from the first spool 510 to the second spool 520 is tensioned with less or no slack. Moving the applicator along the surface S causes the semi-scored double sided tape product 600 to move around the transfer roller 540 due to friction with the surface S. The semi-scored double sided tape product 600 is thus unwound from the first spool 510. On the other hand, the second spool 520 rotates in the same direction as that of the first spool 510 because the second spool 520 is connected to the first spool 510 using a gear mechanism as described above. The second spool 520 can thus take up the semi-scored double sided tape product 600 after the adhesive tape segment(s) is/are transferred to the surface S.

1. A semi-scored double-sided tape product comprising:
adhesive tape segments applied to one surface of a release tape in such a manner that they are transferable to a predetermined surface, each adhesive tape segment having an appropriate length and having adhesive layers on both sides thereof, wherein
the release tape has a thickness of smaller than 25 μm.

2. The semi-scored double-sided tape product according to claim 1, further comprising:
a first spool on which the semi-scored double-sided tape product is wound;
a transfer unit for transferring the adhesive tape segment of the semi-scored double-sided tape product unwound from the first spool, to the predetermined surface;
a second spool adapted to take up the semi-scored double-sided tape product that has passed across the transfer unit; and
a handheld case, the first spool and the second spool being contained in the handheld case, the transfer unit being exposed from the handheld case.
